(19) United States
(12) Patent Application Publication
(10) Pub. No.: US 2020/0386204 A1
(43) Pub. Date: Dec. 10, 2020

(54) CONTROL METHOD FOR CONTROLLING A WIND TURBINE AND A WIND TURBINE COMPRISING CONTROL MEANS CONFIGURED FOR CARRYING OUT THE CONTROL METHOD

(71) Applicant: Siemens Gamesa Renewable Energy Innovation & Technology S.L., Sarriguren (ES)

(72) Inventors: Octavio Hernandez Mascarell, Madrid (ES); Rosa-María Martínez-Vega, Fuenlabrada, Madrid (ES); Ketan Daniel Tigga, Eastleigh (US); Carlos Pizzaro De La Fuente, Madrid (ES); Jaime Suarez Aizpun, Madrid (ES); Pablo Vital Amuchastegui, Pamplona (ES)

(21) Appl. No.: 16/772,465

(22) PCT Filed: Dec. 4, 2018
(86) PCT No.: PCT/EP2018/083428

§ 371 Date: Jun. 12, 2020

(30) Foreign Application Priority Data
Dec. 14, 2017 (ES) P201700794

(51) Int. Cl. F03D 7/02; F03D 9/25

(52) U.S. Cl. CPC F03D 7/0224; F03D 7/0204; F05B 2270/802; F05B 2260/966; F05B 2270/328; F03D 9/25

(57) ABSTRACT

A control method for controlling a wind turbine comprising a rotor hub with a shaft and at least two blades, and a nacelle rotatably coupled to the tower through a yaw system, is provided. The control method includes steps for measuring a first periodic variable relating to the nacelle, measuring a second periodic variable relating to the shaft, estimating a yaw moment based on the data obtained from the first variable, processing the signal corresponding to the estimated yaw moment to extract a 1P frequency component from the signal, calibrating the yaw moment estimated, and adjusting the pitch angle of the corresponding blade to counteract the 1P frequency component of the estimated signal of the yaw moment after calibration, in turn comparing it with the signal of the second variable, is also provided.

### CROSS-REFERENCE TO RELATED APPLICATIONS

This application is a national stage entry of PCT Application No. PCT/EP2018/083428, having a filing date of Dec. 4, 2018, which claims priority to Spanish Patent Application No. P201700794, having a filing date of Dec. 14, 2017, the entire contents of which are hereby incorporated by reference.

### FIELD OF TECHNOLOGY

The following relates to a control method for controlling a wind turbine and to a wind turbine comprising control means configured for carrying out the control method.

### BACKGROUND

Wind turbines suitable for generating electrical energy through the action of the wind on their blades are known to comprise a tower anchored to the ground, a rotor having at least two blades coupled thereto and a nacelle coupled to the tower by means of a yaw system, the nacelle including, among other elements, a generator and a transmission system which allows amplifying the rotating speed of the rotor in the generator. The yaw system comprises at least one bearing fixed to the tower and at least one motor allowing rotation of the nacelle with respect to the tower.

Additionally, imbalances caused in the rotor of a wind turbine are known to give rise to oscillations in the mechanical components thereof, i.e., in the transmission system, the yaw system and/or the generator, which result in the mechanical components becoming worn and even breaking. Due to their positioning, and/or to the fact that the blades of each wind turbine are not exactly the same, each blade can be subject to different aerodynamic forces. Among other consequences, said different aerodynamic forces cause an oscillation torque in the rotor which is transferred to the transmission system of the wind turbine and from there to the generator of the wind turbine. Said oscillation torque is also known as 1P (1 per revolution) oscillation because the vibrations caused by said torque oscillate at the pace of one turn of the rotor. This oscillation torque affects most components of the wind turbine.

One of the solutions to this problem is the calibration of the pitch angle of each blade, i.e., the difference of the pitch angle between the blades is measured and a compensation for the pitch angle of each blade is calculated based on this data, said compensation depending on turbine type. Said compensation system requires expensive equipment and the compensation must be performed periodically to assure that the problem does not arise again.

The document by KK WIND Solutions entitled “Rotor imbalance cancellation” describes a solution based on continuously measuring nacelle acceleration and rotor azimuth position, such that a vector showing the size of the imbalance as well as the position of the imbalance is calculated based on said variables. A new compensation pitch angle for each blade that seeks to minimize the amplitude of the vector is calculated based on this vector.

On the other hand, patent document WO 2010/100271 A1 describes a yaw system for a wind turbine comprising a control system which continuously operates the at least one yaw motor in such a way that the yaw motor strives to maneuver the nacelle according to a set point, allowing the nacelle to divert from the set point if an external yaw wise torque on the nacelle exceeds an allowed torque capacity of the at least one yaw motor. The control system can achieve a four-quadrant control, such that the yaw motor operates as a generator in the second or fourth quadrants, whereas the operation of at least one yaw motor in the first and third quadrants can be stopped in the event of a wind speed above a predetermined level. This control system furthermore detects imbalances in the rotor using at least one property of the yaw motor and subsequently minimizes said imbalance by altering the pitch angle of at least one turbine blade.

### SUMMARY

An aspect relates to a control method for controlling a wind turbine and a wind turbine comprising control means configured for carrying out the control method.

An aspect relates to the control method for controlling a wind turbine comprising a rotor hub including a rotor with a shaft and at least two blades, a nacelle including a generator coupled to the shaft, the nacelle being rotatably coupled to the tower through a yaw system and the rotor hub being rotatably coupled to the nacelle, the control method comprising the following steps:
measuring a first periodic variable relating to the nacelle,
measuring a second periodic variable relating to the rotor,
estimating a yaw moment based on the data obtained from the first variable, processing the signal corresponding to the estimated yaw moment to extract a 1P frequency component from said signal, and
calibrating the yaw moment estimated according to which a known imbalance is forced in at least one of the blades and the effect thereof on the measurements of the first variable is measured, establishing a correction factor which is applied to estimation of the yaw moment, and
adjusting the pitch angle of the corresponding blade to counteract the 1P frequency component of the signal of the yaw moment estimated after calibration, in turn comparing it with the signal of the second variable.

A control method which completely eliminates aerodynamic imbalance regardless of the measuring device used and the type of signal selected is thereby obtained.

Furthermore, the control method can be carried out in real time and by any programmable logic controller, also known as PLC.

A second aspect of the present invention relates to the wind turbine comprising a tower, the rotor hub including a rotor with a shaft and at least two blades, the nacelle including a generator coupled to the rotor, the nacelle being rotatably coupled to the tower through a yaw system and the rotor hub being rotatably coupled to the nacelle, and control means configured for carrying out the control method.

These and other advantages and features of the embodiment of the present invention will become evident in view of the drawings and the detailed description.

### BRIEF DESCRIPTION

Some of the embodiments will be described in detail, with reference to the following figures, wherein like designations denote like members, wherein:

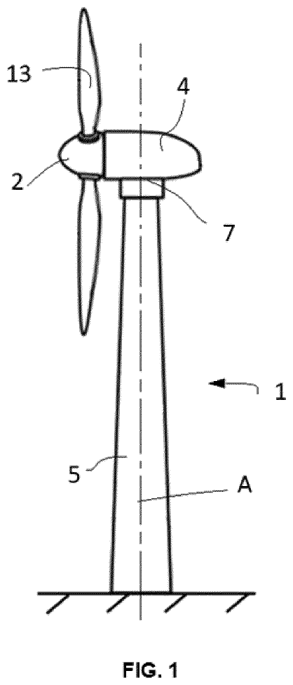

FIG. 1 depicts a view of an embodiment of a wind turbine; and

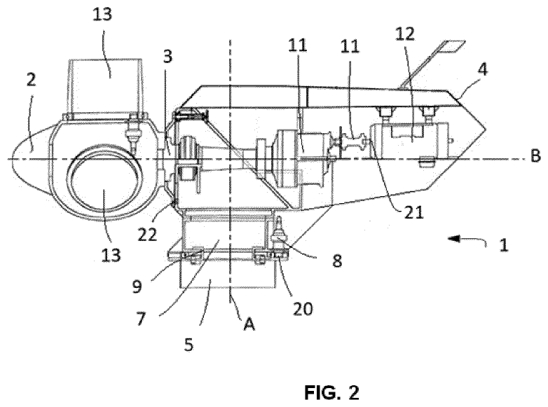

FIG. 2 depicts a schematic sectioned view of the wind turbine shown in FIG. 1.

### DETAILED DESCRIPTION

FIGS. 1 and 2 show a wind turbine 1 comprising a tower 5 anchored to the ground, a rotor hub 2 including a rotor with a shaft 3 and at least two blades 13 coupled to the hub 2, and a nacelle 4 rotatably coupled to the tower 5 through a yaw system 7. The nacelle 4 can rotate about an axis A extending along the length of the tower 5 for the purpose of orienting the blades 13 depending on the direction of the wind in order to obtain optimal performance of the wind turbine 1. Additionally, the rotor hub 2 is rotatably coupled to the nacelle 4, where it can rotate about a substantially horizontal axis B. In the embodiment shown in the drawings, the rotor hub 2 comprises three blades 13 arranged offset 120° with respect to one another.

The nacelle 4 further comprises a generator 12, at least one brake suitable for braking the rotation of the nacelle 4 with respect to the tower 5, and a transmission system 11 through which the shaft 3 is connected with the generator 12. Given that the shaft 3 has a low rotating speed, the purpose of the transmission system 11 is to obtain a suitable rotating speed in the generator 12.

The yaw system 7 comprises at least one bearing 9 fixed to the tower 5, and at least one motor 8 that enables rotation of the nacelle 4 with respect to the tower 5.

The wind turbine 1 further comprises at least a first sensor 20 measuring a first variable relating to the nacelle 4. The first sensor 20 measures a periodic signal. In the described embodiment, the first sensor 20 measures a current of the motor 8 of the yaw system 7, said first sensor 20 being arranged in said yaw system 7. In other embodiments, the first sensor 20 can measure the speed of the generator 12 or the acceleration of the nacelle 4. In said embodiments, the first sensor 20 would be arranged in the generator 12 or in the nacelle 4, respectively.

The wind turbine 1 comprises at least a second sensor 21 measuring a second variable relating to the generator 12, said second sensor 21 being arranged in the nacelle 4. The second sensor 21 measures a periodic signal. In the described embodiment, the wind turbine 1 comprises the second sensor 21 measuring the rotating speed of the generator 12 and a third sensor 22 which is used to obtain an angular reference with respect to a fixed point of the turn of the shaft 3. Said third sensor 22 is also arranged in the nacelle 4. The value of the azimuth angle of at least one of the blades 13 is obtained by means of the second sensor 21 and the third sensor 22. The value of the azimuth angle that is obtained is continuously corrected in each complete turn of the shaft 3. To that end, there is arranged in the shaft 3 a plate (not depicted in the drawings) which rotates with said shaft 3. An inductive sensor (not depicted in the drawings) captures the signal that is produced when the plate passes by the inductive sensor, the data measured through the inductive sensor is then compared with the value of the azimuth angle obtained through the second sensor 21 and third sensor 22, with possible deviations being corrected.

The wind turbine 1 further comprises control means configured for carrying out the control method that will be described in detail below.

When at least one of the blades 13 is subject to different aerodynamic forces, either due to its positioning with respect to the direction of the wind and/or because not all the blades 13 are exactly the same, a force is generated in the shaft 3 which rotates with the shaft 3 itself causing a vibration in the shaft 3 which oscillates according to a 1P frequency. This vibration is transmitted to the other elements of the wind turbine 1, even reaching the generator 12. In order to minimize the effect produced on the rest of the components of the wind turbine 1 as a result of the imbalance of different aerodynamic forces in the blades 13, the purpose of the control method for controlling the wind turbine according to the embodiment of the present invention is to detect said imbalance to then counteract the 1P frequency vibration generated by said imbalance by acting on the pitch angle of the corresponding blade/blades 13 causing the imbalance.

The control method comprises the following steps:
measuring a first periodic variable relating to the nacelle 4,
measuring a second periodic variable relating to the shaft 3,
estimating a yaw moment based on the data obtained from the first variable,
processing the signal corresponding to the estimated yaw moment to extract a 1P frequency component from said signal,
calibrating the estimated yaw moment according to which a known imbalance is forced in at least one of the blades 13 and the effect thereof on the measurements of the first variable is measured, establishing a correction factor which is applied to the estimated yaw moment,
adjusting the pitch angle of the corresponding blade 13 to counteract the 1P frequency component of the signal of the estimated yaw moment after calibration, in turn comparing the pitch angle with the signal of the second variable.

In a first step, the first variable is measured through the first sensor 20, with said first variable being the current of the motor 8 of the yaw system, the rotating speed of the generator 12 or the acceleration of the nacelle 4. The yaw moment is then estimated based on the signal of the data obtained from the first variable. The periodic signal corresponding to said estimated yaw moment is processed based on said estimated yaw moment, and the 1P frequency component is extracted from said signal. A calibration step is then carried out according to which a known imbalance is forced in at least one of the blades 13 and the imbalance it causes is measured, establishing a correction factor which is applied to the estimated yaw moment.

The calibration step allows identifying the relationship between the measurement of the first variable and the imbalance it represents. Particularly, a known forced angular error is applied to one of the blades 13, and the signal of the first sensor 20 which measures a 1P frequency sine wave of certain amplitude is measured. In other words, the proportionality between the measurement of the first sensor 20 and the error introduced in one of the blades 13 is established. The phase of the imbalance forced in one of the blades 13 is determined by comparison with the azimuth measured by the first sensor 20.

The calibration step is carried out once for each wind turbine 1, applying the same correction factor to correct, from then on, the corresponding yaw moment estimate based on the data obtained from the first variable.

The signal corresponding to the estimated yaw moment is then processed and corrected to extract the 1P frequency component from said signal and the pitch angle of the corresponding blades 13 is adjusted to counteract the 1P frequency component of the signal of the estimated yaw moment after calibration, in turn comparing the pitch angle with the signal corresponding of the second variable.

The processing step for processing the signal corresponding to the estimated yaw moment to extract a 1P frequency component from said signal is carried out through a Goertzel algorithm. This algorithm is known in the state of the art, so it is not considered necessary to explain it in more detail. The amplitude and phase of the extracted 1P signal are known as a result of said algorithm. The amplitude provides the extent, in degrees, to which the blades 13 are offset, whereas the phase of the 1P signal is compared with the signal obtained through the measurement of the second variable. The comparison of the phase of the extracted 1P signal and of the azimuth signal of the second variable provides for the offset, in degrees, between the two signals and therefore the imbalance to be corrected, i.e., it indicates in which blade or blades 13 the imbalance, which is corrected by means of adjusting the pitch angle of the corresponding blades 13, occurs.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. A control method for controlling a wind turbine comprising a rotor hub including a shaft and at least two blades, a nacelle including a generator coupled to the shaft, the nacelle being rotatably coupled to the tower through a yaw system and the rotor hub being rotatably coupled to the nacelle, the control method comprising:
measuring a first periodic variable relating to the nacelle;
measuring a second periodic variable relating to the shaft;
estimating a yaw moment based on data obtained from the first variable;
processing a signal corresponding to the yaw moment to extract a 1P frequency component from the signal; and
calibrating the yaw moment according to which a known imbalance is forced in at least one of the blades and an effect thereof on the measurements of the first variable is measured, establishing a correction factor which is applied to the yaw moment; and
adjusting a pitch angle of the corresponding blade to counteract the 1P frequency component of the signal of the yaw moment after calibration, in turn comparing it with a signal of the second variable.

2. The control method for controlling a wind turbine according to claim 1, wherein the calibration step is carried out once for each wind turbine, applying the same correction factor to correct the estimation of the corresponding yaw moment based on the data obtained from the first variable.

3. The control method for controlling a wind turbine according to claim 1, wherein the processing step for processing the signal corresponding to the estimated yaw moment to extract a 1P frequency component from the signal is carried out through a Goertzel algorithm.

4. The control method for controlling a wind turbine according to claim 1, wherein there are obtained through the Goertzel algorithm the amplitude of the extracted 1P signal indicating the extent, in degrees, to which the corresponding blade is offset and a phase of the extracted 1P signal which is compared with the signal of the second variable, providing the offset, in degrees, between both signals indicating in which blade the imbalance occurs.

5. The control method for controlling a wind turbine according to claim 1, wherein the first variable is a yaw current, a speed of a generator comprised in the nacelle or an acceleration of the nacelle.

6. The control method for controlling a wind turbine according to claim 1, wherein the second variable is an azimuth angle of the shaft.

7. A wind turbine comprising a tower, a rotor hub including a shaft and at least two blades, and a nacelle including a generator coupled to the shaft, the nacelle being rotatably coupled to the tower through a yaw system and the rotor hub being rotatably coupled to the nacelle, wherein the wind turbine further comprises a control means configured for carrying out the control method according to claim 1.
